(19) United States
(12) Patent Application Publication
(10) Pub. No.: US 2007/0080308 A1
(43) Pub. Date: Apr. 12, 2007

(54) Dental x-ray radiation protection device

(75) Inventor: Saeideh Mousavi Yeganeh, Vancouver (CA)

Correspondence Address: Saeideh Mousavi Yeganeh, #212 - 3250 West Broadway, Vancouver, BC, V6K 2H4, CA

(73) Assignee: Ms. SAEIDEH MOUSAVI YEGANEH, Vancouver (CA)

(21) Appl. No.: 11/512,147

(22) Filed: Aug. 30, 2006

(30) Foreign Application Priority Data
Oct. 12, 2005 (CA) 2522775

(51) Int. Cl. G21F 3/00

(52) U.S. Cl. 250/515.1

(57) ABSTRACT

A dental x-ray radiation protection device/system reduces radiation exposure to patient(s) and the surrounding environment around patient(s) in dental clinics during x-ray radiography procedures. It provides maximum protection for the areas of the patient's body which are not protected with radiation protection (Lead) apron. The invented device/system is adjustable at different angles and directions to target teeth and comprises of two main segments that provide radiation reduction. The device could be attached to a dental x-ray machine as a mount frame or stand frame or even be hung from the ceiling or wall of the x-ray room. Thicknesses of the radiation protection shield for all parts of device are calculated using radiation physics equations by solving for thickness of radiation shield material(s) with respect to x-ray beam intensity, x-ray beam energy, mass or linear attenuation coefficient and density of radiation protection material(s) to get up to 99.9% radiation reduction.

### FIELD OF THE INVENTION

This invention relates to a radiation protection system that protects patients, as well as clinical staff against x-ray radiation and its adverse effects during dental diagnostic radiography procedures in dental clinics.

### BACKGROUND OF THE INVENTION

An x-ray machine is a diagnosis tool which is used in today's dental clinic practice to check for cavities and other dental problems in patients. X-ray radiation is transmitted through an aluminium or plastic output tube at the end of the x-ray machine. When exposed to x-rays, patients are provided with a lead apron or a radiation protection apron, covering their chest and shoulders in order to protect their bodies from harmful effects of radiation. The apron protects patient's body from unnecessary, secondary and scattered x-ray radiation. However, the apron can not provide full protection for the patient since patient's entire face, eyes and head (as well as for the neck and shoulder if the protective apron has no collar and full shoulder protection) is exposed to radiation. Moreover, generally, x-ray machine output tube does not provide significant reduction in levels of radiation that are emitted in all directions in the clinic environment towards patient's body. Scientific studies show that repeated exposure to ionizing radiation or high dose exposure to ionizing radiation is harmful to the human body. Hence, a dental technician or hygienist who operates the x-ray machine leaves the room for the time x-ray machine is activated, in order to minimize exposure to harmful radiation.

Current methods of protection such as the lead apron or radiation protection apron do not provide protection for patient's face, eyes and head. What will happen to the rest of patient's body such as the face, neck (where thyroid gland is located), eyes and head? Depending on safety equipment used in different clinics, parts of patient's neck and shoulders may be exposed to radiation. Some clinics use lead aprons or radiation protection aprons that come with collar sections for the protection of the Thyroid gland and the neck. Not all dental clinics use aprons with collar sections for protecting patient's neck.

Although radiation exposure in dental clinics or other radiological facilities may not result in significant danger to the patient, in many cases however, certain body structures are particularly at risk when it comes to x-rays and similar radiation. Hence, protective shields have been provided to limit the unnecessary exposure of patient's body as well as the personal who administrate the x-ray treatment. One area of interest is patient's face and head which make up a small area and are difficult to protect while a dental x-ray is being done. One of the main objectives of this invention is to solve this problem by protecting patient's entire face including skin, eyes, head and neck. During a typical dental x-ray session, the abovementioned areas are not completely protected by lead aprons or any radiation protection shields and are unnecessarily exposed to radiation.

Moreover, ionizing radiation such as x-ray interacts with matter in radiography clinic environments. It interacts with air molecules as well. Such environments contain increased levels of background radiation since there is probability for interaction between x-ray and matter, as a result atoms of matter might be ionized. Higher radiation makes more background radiation and consequently increases health risks. Therefore, some regulatory organizations require complete shielding of rooms in which radiation equipment is being operated. If designed properly, such shielding around the x-ray room provides adequate and reliable barrier between radiation and the people outside the room. While protecting the patient, this invention absorbs most of the primary, secondary and scattered x-ray generated by x-ray machines and consequently reduces radiation exposure in clinic environment.

One theory on the relationship between absorbed radiation dose and the probability of health effects constitutes a linear relationship between threshold and an increase in the probability of developing fatal diseases such as cancer. Gradual doses, however small, can result into fatal diseases over years due to many known and unknown factors. ALARA is a principle to occupational Radiation Protection & Safety which indicates that radiation dose should be As Low As Reasonably Achievable.

Previously, cases where faulty equipment resulted in overexposure of patients to radiation have been reported in the past. For example, in Ireland, in year 2000, a faulty x-ray machine, resulted in a patient being overexposed to radiation. X-ray radiation has no color or smells. In such cases, unless regular radiation surveys are done, a faulty medical x-ray machine may operate and leak extra doses of radiation for years before the malfunction is discovered. This invention can also protect patients and staff against cases of faulty machines until the problem is discovered and the x-ray machine is repaired.

There are a few prior art patents published for shielding and protecting against x-ray radiation. These patents describe various shields made of radiation protection shield materials and compositions and various radiation protection shields with different shapes and appearances. However, there is no significant protection against x-ray radiation by a method, a device or a system that does not conflict with the x-ray dental procedure for the patient whose face, nose, head and eyes are exposed to dental x-ray radiation while x-rays images are being taken. This is vital in particular when there is unexpected radiation leakage generated by an x-ray machine either from a new or old x-ray machine and/or even if the medical x-ray generator has a radiation alarm system that may not work. In these cases the patient is protected by this invention. In such cases and during normal operation of x-ray machine, this invention reduces radiation exposure by absorbing secondary and scattered x-ray.

### SUMMERY OF THE INVENTION

It is in view of the above that the invention was developed. The preferred embodiment is a Dental X-Ray Radiation Protection System. The invention provides maximum protection for patients. Normally in dental radiography when taking x-rays, patient's face, head, neck, shoulders and the eyes are unnecessarily exposed to radiation. The invention is unique because, it reduces patient's exposure to x-ray radiation for dental radiography by up to 99% (or equal to background radiation of the dental clinic) for areas of patient's body which are not protected by radiation protection aprons including entire face, head and eyes for the moment that dental x-rays are taken. The configurations of the invention protect patient's neck and shoulders when patient wears a radiation protection apron which have a collar to protect patient's neck and may be large enough to protect patient's shoulder and hands. Further, the invented system is also efficient when the lead or radiation protection apron has no protective collar and is not large enough to protect the neck, shoulders and hands.

The invented system reduces radiation exposure to patients and clinic environment in two stages. A general relationship exists between x-ray energy, thickness of shielding material and type of radiation protection material(s) or composition(s). The higher the radiation energy and intensity, the thicker the radiation shield material should be. Function of this invention is based on the abovementioned relationship.

The invention comprises of a collimating section that allows for maximum transmission for x-rays to targeted teeth and does not affect film resolution. The invention provides a first stage x-ray radiation protection and does not allow the x-ray radiation to scatter. A clear X-Ray radiation protection shield section provides the final level of x-ray radiation protection that is not completely filtered in the first stage.

The invention allows the dentist or dental assistant to position the x-ray tube of dental x-ray machine or x-ray machine in any desired position in order to target the teeth under investigation. Since the invented system has a transparent part, the dental examiner can position and orient the x-ray machine at an appropriate location to target the desired teeth. This transparent part provides the final stage of the x-ray radiation protection for the patient and minimizes the amount of exposure to the patient with respect to the thickness of material and kind of shield material. The invention provides maximum protection for the patient for areas of patient's body which are not protected by a radiation protection apron.

The invented system is feasible for practical dental x-rays, and does not impact the x-ray film or the outcome images that have been generated by dental x-ray radiography. It also does not affect film's contrast. On the other hand in practice usage of this invention does not conflict with the current x-ray dental radiology procedures, since x-rays can be taken at many angles and orientations. The invented system protects areas of patient's body such as the face, which in the current practice is unnecessarily exposed to radiation.

### BRIEF DESCRIPTION OF DRAWINGS

FIG. 1 illustrates the general arrangement of a patient in a dental clinic, showing exposure of patient to radiation and distribution of radiation to the surrounding environment in the absence of the invented system.

FIG. 2 illustrates the practical performance or usage of the invented system and shows how the invented system protects the patient.

FIG. 3 illustrates the practical performance or usage of the invented system and alternative embodiment of the invented system.

FIG. 4 illustrates a more detailed picture of the invented system shown in FIG. 2.

FIG. 5 illustrates isometric projections of the invented system.

FIG. 6 illustrates a three-dimensional isometric view of the invention as portrayed in FIG. 3.

FIG. 7 illustrates a close up of the invented system as portrayed in FIG. 6 with details from a side view.

FIG. 8 illustrates the invented system that is mounted on adjustable arms and hangs from the ceiling so that the invention does not occupy limited space of the x-ray room.

FIG. 9 illustrates the invented system that is mounted on adjustable arms and hangs from the wall so that the invention does not occupy limited space of the x-ray room.

### DETAILED DESCRIPTION OF EMBODIMENT OF THE INVENTION

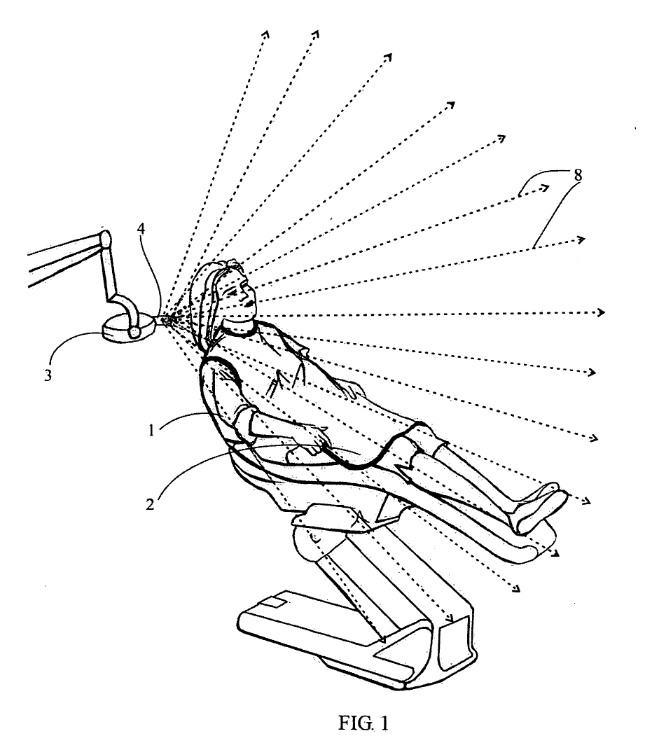

Referring to FIG. 1, in practice a patient (1) wears a lead apron or radiation protection apron (2) that may or may not have a collar and be large enough to completely cover patient's neck, shoulder and hands. Dental x-ray machine (3) emits x-ray radiation (8) from an output tube (4) in all angles and directions in space of the dental examination room or the dental x-ray room. X-ray radiation reaches all parts of patient's body that are not covered by the radiation protraction apron (2) including all face, face skin, head, nose, eyes and eye lenses, neck, shoulders, and hands.

This figure illustrates how a patient that wears a radiation protection apron is exposed to x-ray radiation in the absence of the invented system.

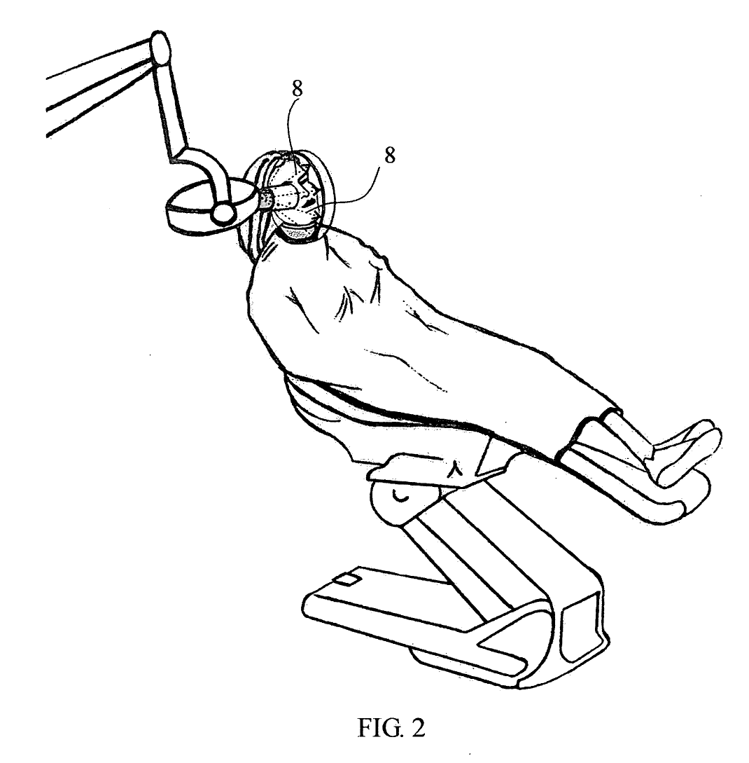

FIG. 2 illustrates a practical application of the invention for protection of patient's head, face, face skin, nose, eyes and eye lenses, when the patient wears a radiation protection apron, which has a collar to protect the neck and is large enough to cover patient's shoulders completely. When compared to today's typical practice as portrayed in FIG. 1, the invented system as illustrated in

FIG. 2 reduces exposure of patient's body to x-ray radiation (8) and reduces emission or distribution of radiation (8) which is produced by x-ray machine in clinic environment.

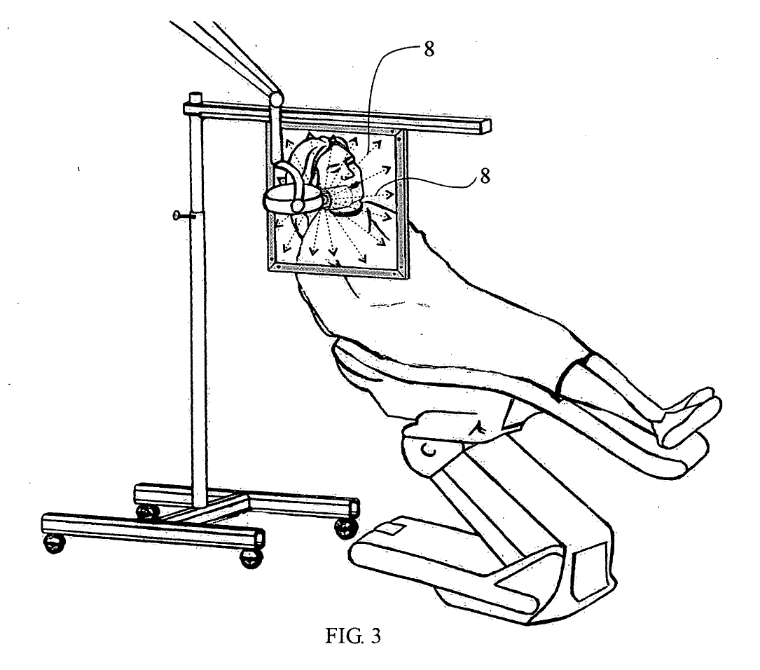

FIG. 3 illustrates a practical application of the invented system in an alternative arrangement when mounted on an independent frame, to protect patient's head, face, face skin, nose, eyes, eye lenses, neck, shoulders and hands, when the patient wears a radiation protection apron, which does not have a collar to protect the neck and is not large enough to cover patient's shoulders completely. In this case the invented system as illustrated in FIG. 3 reduces exposure of patient's body to x-ray radiation (8). When compared to today's typical practice as portrayed in FIG. 1, the invented system as illustrated in FIG. 3 reduces exposure of patient's body to x-ray radiation (8) and reduces radiation (8) which is produced by x-ray machine in clinic environment.

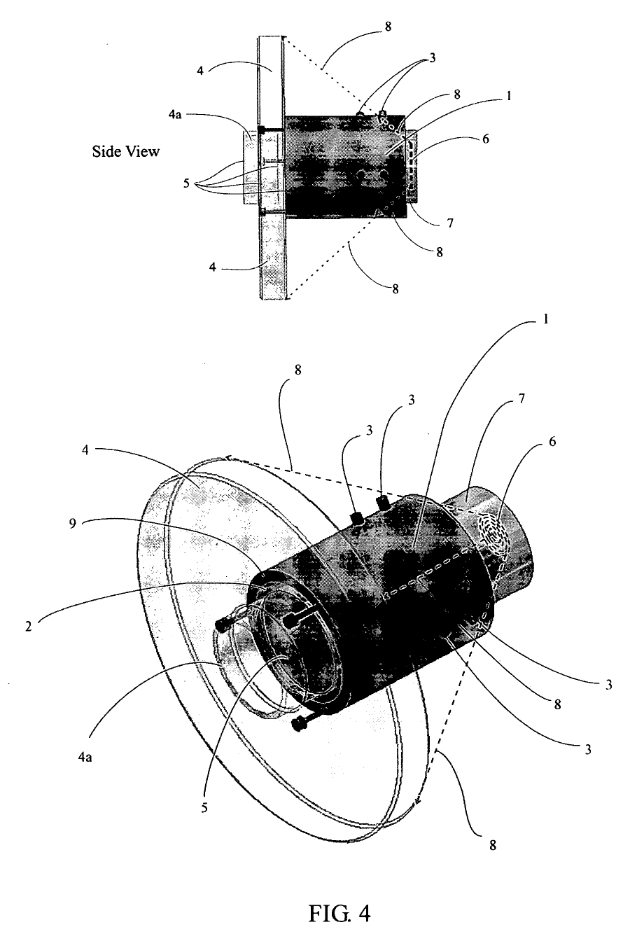

The invented system is feasible and practical and provides maximum radiation protection for the patient as illustrated in FIGS. 4, 5, 6, and 7. Referring to the attached drawings in FIGS. 4, 5, 6, and 7 the invented system comprises of a Collimating section (1) that provides the first stage of protection against exposure to x-ray radiation and does not allow the x-ray radiation to scatter. The collimator section (1) of the invented system is attached to a section (4) as shown in FIGS. 4, 5, 6, and 7. The inside diameter (5) of the collimating section is approximately equal to (not less than) the inside diameter of the x-ray output tube so that the maximum x-ray beam can reach targeted teeth for investigation. Adding any other collimator inside the collimating section (1) decreases size and the amount of mentioned cross section. As a result, teeth x-ray image resolution is decreased because the x-ray beam will be narrower and the focal point resolution will be less. In this invention there is no internal collimator for this part (1). The material that is used for the mentioned section (1) could be plastic or aluminium or any other material and compositions. The inside of collimator (1) is covered by heavy element with high atomic number element(s) such as lead foil (2) (or with any coated radiation protection material or composition with atomic number higher than of Lead). Moreover, when the wall thickness (9) of collimator (1) is not sufficient to perform first stage radiation protection, thickness of coated radiation protection material/composition or radiation protection foil (2) are calculated with respect to the x-ray energy, type of radiation protection shield material composition(s) or shield material element(s). Thickness calculation is described in the further paragraphs.

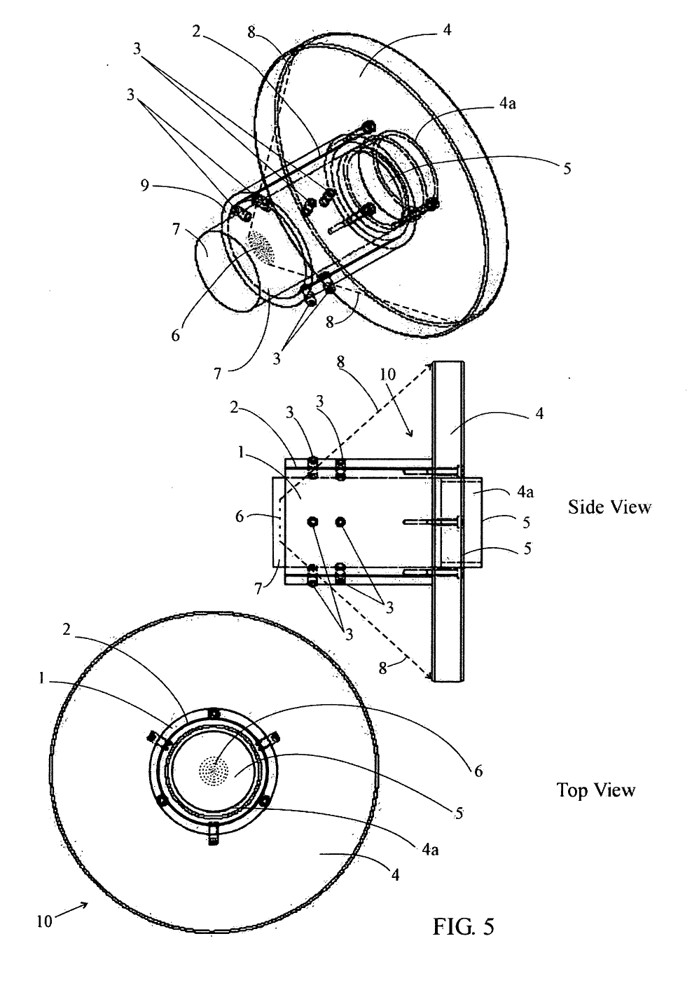

Referring to the attached drawings (FIGS. 4, 5, 6, and FIG. 7), diameter of the collimator (1) and the inside diameter of opening (5) in center of the lead acrylic shield (4) could be customized for different manufactured x-ray machines. Referring to FIG. 4 and FIG. 5 the collimating part (1) of the invented system has a clamping mechanism (3) which normally would comprise of set screws in order to secure the invention to output tube of an x-ray machine. However, the clamping mechanism (3) may not be limited to set screws and may be of any design.

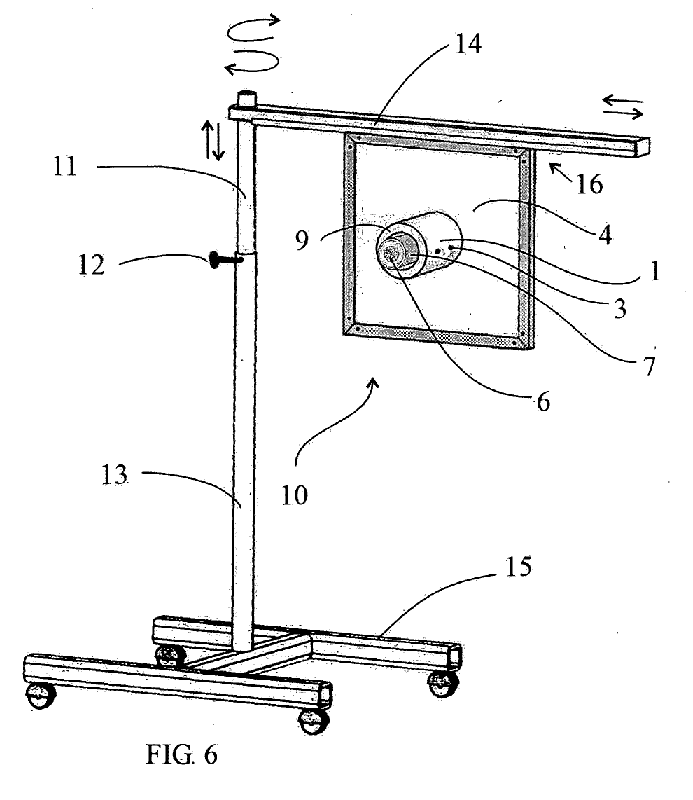

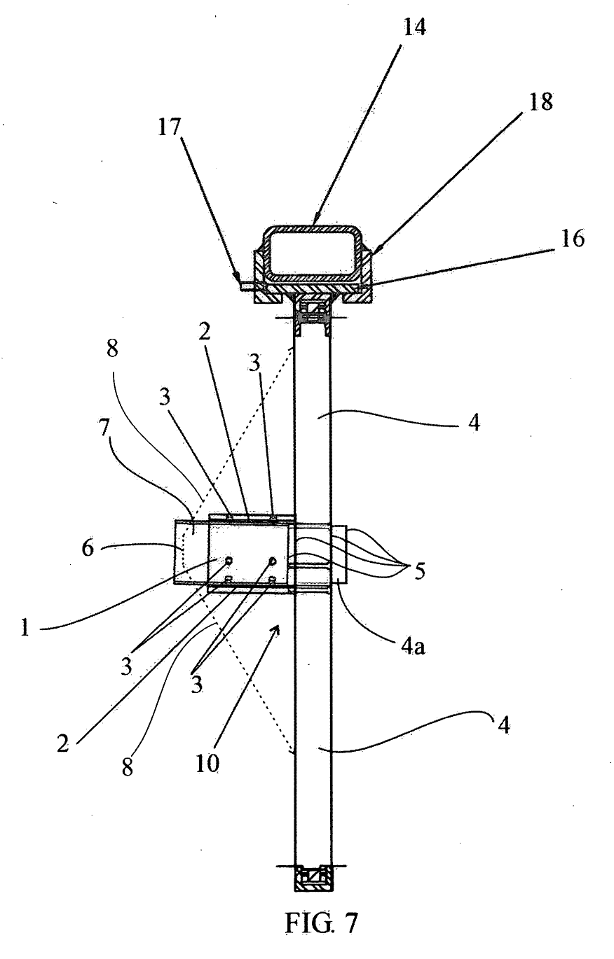

X-ray radiation is emitted from x-ray machine through an output tube (7) with a conical angle as shown in FIG. 4 (8). The collimator (1) is attached to x-ray output tube (7). X-ray radiation (8) will be filtered at this section significantly as per given calculation in the further paragraphs. Advantage of having a collimating section (1) is that this part absorbs significant portion of x-ray radiation and prevents some portion of x-ray radiation from reaching the air. Since x-ray is an ionizing type of radiation, using the invented system reduces possibility of ionizing air molecules and reaching radiation from x-ray machine to the room environment. The portion of radiation which is not completely absorbed will exit the collimating section (1) due to the conical angle. This portion of radiation is then absorbed through an acrylic lead or Clear-Pb shield (4). The collimating section (1) and acrylic lead or Clear-Pb shield (4) do not restrict the amount of radiation that has to reach the teeth under examination by dentist. Hence, the invention as illustrated in FIG. 4, FIG. 5, FIG. 6 and FIG. 7 protects portions of patient's body which are not covered by radiation protection apron, while not altering x-ray image quality or image resolution.

Following the collimating part (1) the invented system also comprises of a clear or transparent x-ray radiation protection section (4), which provides final level of protection for x-ray radiation and allows the dentist, dental assistant, or technician to see the location where x-ray tube has to be positioned against patient's face. The clear or transparent radiation shield material for section (4) [FIG. 4 (4), FIG. 5 (4), FIG. 6 (4), and FIG. 7 (4)] could be lead Acrylic, Clear-Pb, or clear plastic lead but not limited to these materials. Clear-Pb has 30% lead. However, it could be composed of higher percentage of the lead or any other radiation protection material(s) or composition(s) or sandwich of several transparency shield materials.

There is no limitation for radiation protection shield material(s) or composition(s). However, part (4) is transparent in order for dentist to observe which teeth are targeted. As illustrated in FIG. 4 (4), FIG. 5 (4), FIG. 6 (4), and FIG. 7 (4) the final level of protection for x-ray radiation section (4) of the invented system has an opening (5) with diameter that is approximately equal to inside diameter of collimator (1). Opening (5) diameter is approximately equal to inside diameter of x-ray output tube (7). This allows emitted radiation produced by x-ray machine to reach patients teeth under examination. Configuration of the collimator (1) and the final level of protection for x-ray radiation section (4) do not alter x-ray image quality or resolution. The configuration of collimator (1) and final level of protection (4) section provides up to 99% (or equal to background radiation) protection depending on thickness of the transparent radiation protection shield material(s), composition(s), type of radiation shield composition(s) and energy of x-ray machine.

X-ray output tube (7) and output of x-ray machine (6) [means x-ray beam (6) and x-ray beam cross section (6)] is not the part of invented system. The invented system is attached to (7). However, the invented system could be configured as part of a compact x-ray machine and designed as part of any x-ray machine in particular dental x-ray machines.

Calculations for the Appropriate Radiation Protection Shield Thickness:

Intensity of radiation (I) after passing through shield material depends on several factors including: initial intensity (I₀), thickness of shield material (X) and element or composition of shield material. For example, heavy material and composition of heavy materials (or materials with higher atomic number) such as lead is often used in radiation protection applications. The relationship between initial radiation intensity and intensity after passing through the radiation shield is expressed by equation 1.
I=I₀e^{-μX} (Equation 1)

I is the amount of radiation intensity after passing through radiation protection shield material (or intensity outside of a shield of thickness x).

I₀ is the amount of initial radiation intensity before passing through the shield material (or the unshielded intensity).
X is thickness of radiation shield material,
ρ is density of the radiation shield material
μ is Linear Attenuation Coefficient
μm is Mass Attenuation Coefficient and defined as follow:

Mass attenuation and linear attenuation coefficients are calculated as per equations 2 and 3 respectively.

$$\begin{matrix}Mass Attenuation Coefficient , {μ}_{m} = \frac{μ}{ρ} & ( Equation 2 ) \\ Linear Attenuation Coefficient μ = {μ}_{m} \cdot ρ & ( Equation 3 )\end{matrix}$$

For a given photon energy, μm remains constant. Both Mass and Linear Attenuation Coefficients are functions of radiation intensity (here x-ray intensity). Equation 1 can be solved for X, thickness of shield material, given initial and final radiation intensities as shown below.

$$\begin{matrix}I = {I}_{0} {ⅇ}^{- μ X} \\ \frac{I}{{I}_{0}} = {ⅇ}^{- μ X} ⇒ - Ln \frac{I}{{I}_{0}} = μ X\end{matrix}$$

The thickness of the radiation shield material

$$X = - Ln \frac{I}{{I}_{0}} \times \frac{1}{μ} \qquad ( Equation 4 )$$

I is the amount of radiation after absorption due to a radiation shield which is calculated as follows:
I=I₀−(% Radiation Reduction×I₀) Here I is intensity of output radiation or amount of radiation after absorption by the shield. Also μ and μm are function of radiation energy and type of element/material or composition of shield which is found in standard tables. For intensity reduction of 90% the final intensity after absorption by the shield would be stated as I=0.1(I₀)

$$\begin{matrix}X = - Ln \frac{I}{{I}_{0}} \times \frac{1}{μ} = - Ln \frac{0.1 I}{I} \times {( {μ}_{m} \cdot ρ )}^{- 1} \\ X = Ln ( 0.1 ) \times {( {μ}_{m} \cdot ρ )}^{- 1} = - ( - 2.30258 ) \times {( {μ}_{m} \cdot ρ )}^{- 1}\end{matrix}$$

For 90% reduction, equation 4 is simplified as shown below.
X=2.30258×(μₘ.ρ)⁻¹

On the other hand thickness of the radiation shield might be variable. This method allows choosing precise thickness for radiation protection martial(s) or composition(s) with respect to the parentage of radiation absorption that is required for any radiation protection shield.

Also, referring to FIG. 4, FIG. 5, FIG. 6, and FIG. 7, the thickness of (1), (2), and (4) are calculated precisely, with respect to the amount of x-ray energy generated by x-ray machine, density of shield material(s) or composition(s), and Mass Attenuation Coefficient (μₘ) of the shield according to abovementioned calculations or method.

The invented system has two alternative arrangements such as the mount frame shown in FIG. 4 and FIG. 5 and/or the adjustable/Stand frame as shown in FIG. 6 and FIG. 7. The first applies when the patient wears a radiation protection apron, which has a collar to protect the neck and is large enough to cover patient's shoulders and hands completely. The latter (adjustable/Stand frame) applies when the patient wears a radiation protection apron, which does not have a collar to protect the neck and is not large enough to cover patient's hands and shoulders completely. Both arrangements are flexible and capable of being adjusted in different angles in three-dimensional space. The collimating section (1) and the final level of radiation protection (4) can have various geometries and are not limited to the shapes shown in drawings.

Referring to FIG. 4 and FIG. 5, applications of the invention is suitable for dental clinics that provide protection for patient's neck, hands and shoulders using a large apron with collar. In configurations shown in FIGS. 4 and 5, the invented system protects the entire face, entire face skin, nose, eyes, eye lenses, and head. The invented system could be attached to the output tube of an x-ray machine. For this application, the invented system is attachable to the head of x-ray tube of the x-ray machine. It could be adjusted in all angles, all direction and all heights with respect to allowable range of motion for the x-ray machine as shown in FIG. 4 (10) and FIG. 5 (10). Henceforth (10) refers to assembly of (1) and (4) by screws. However, this connection between (1) and (4) may be done by other means and methods.

Referring to FIG. 6 and FIG. 7, invention application is suitable for dental clinics that do not provide apron with collar and full shoulder protection for their patient. The final level of the protection (4) in the invented system has larger surface in order to protect the neck, shoulders, and even hands of the patient as well, while (4) protects entire face, face skin, nose, eyes, eye lenses, and head. Shape and size of the final level of x-ray protection section (4) is not limited to the given shapes in the FIG. 6 (10) and FIG. 7(10). Construction of the invented system allows for movement of assembly of (1) and (4) in FIG. 6 and FIG. 7, in three dimensions and different angles by having a knob (12) which provides movement for adjusting the height of the invented system. This configuration allows rod (11) to be adjusted in order to setup the invented system in a suitable position/height. Rod (11) fits into a tube (13) and is able to be adjusted vertically by tightening the knob (12). Rod (11) has a smaller diameter than tube (13). Hence it can move vertically and rotate. This feature allows the invented system to be adjusted in two dimensions. Both clear radiation protection shield (4) and collimator (1) shown as assembly (10) are connected to tube (14) via a sliding plate (16). This connection allows (10) [refers to assembly of (1) and (4)] to slide along tube (14) through the space provided by two angles (18) in FIG. 7. In FIG. 7 a set screw (17) locks assembly (10) in its horizontal position; this may be constructed differently than illustrated even with more set screw. However, this sliding arrangement may be constructed differently than illustrated. Assembly (10) and tube (14) can rotate about vertical axis that goes through center of rod (13). Therefore the invented system (10) has ability to move in three dimensions. Part (15) is a frame supported on wheel and supports the assembly of parts (13), (11), (14) and (10).

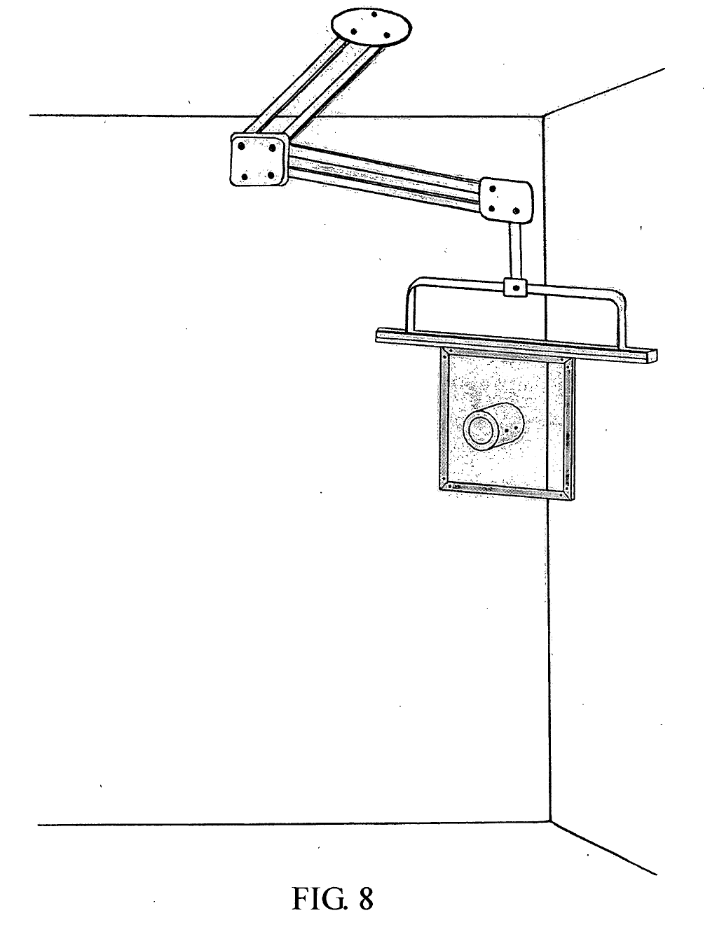

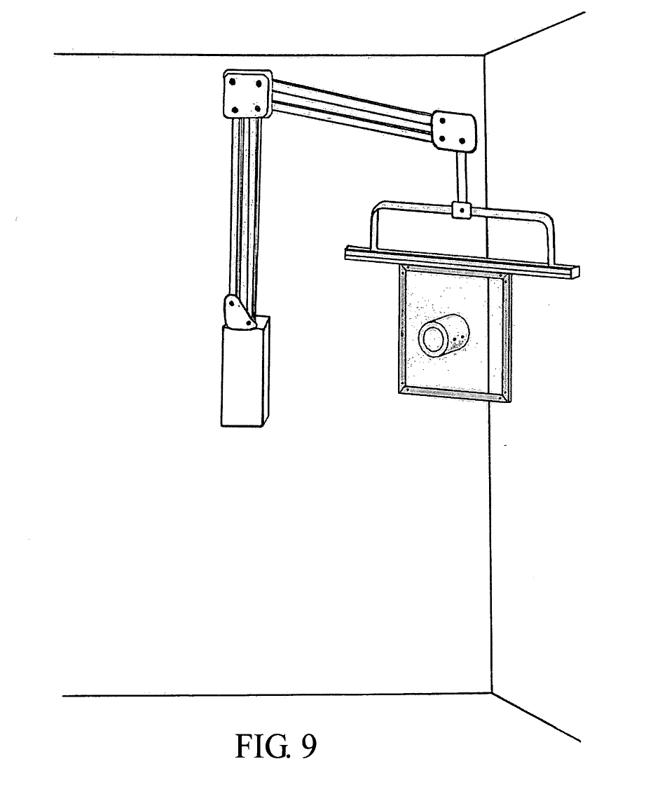

The described invented system is not to be construed as limiting the invention to the precise construction shown. Both clear radiation protection shield (4) and collimator (1) as an assembly (10), may be mounted on adjustable arms and be hung from ceilings or from walls, so that the invention does not occupy limited space of the x-ray room as shown in FIG. 8 and FIG. 9.

I claim:

1. A dental x-ray radiation protection device is systematic and utilizes a method to provide maximum x-ray radiation reduction in two stages for patient(s) in dental radiography and for those areas of patient's body which are not protected with radiation protection apron or lead apron in the practice of dental radiography comprising:
a collimating section (1) which provides the first stage of radiation exposure reduction and protection against x-ray radiation; and
a clear and transparent x-ray radiation protection section (4), which provides the final stage of x-ray radiation reduction and protection against x-ray radiation.

2. The dental x-ray radiation protection device of claim 1, wherein said collimating section (1), is a tube which is inserted over and is connected to the output tube of a dental x-ray machine (7) on one side and is connected to a clear and transparent x-ray radiation protection section (4) on the other side wherein said clear and transparent x-ray radiation protection section (4) in claim 1, and the said collimating section (1) has sufficient length so that it covers completely the output tube of a dental x-ray machine (7).

3. The collimating section (1) of claim 2, wherein said is a tube, has no internal collimating part and has no part(s) inside that would partially block or reduce the amount of the x-ray beam (6) and size of the x-ray beam cross section (6) that is generated from the dental x-ray machine in which the dental x-ray radiation protection device of claim 1 is mounted and connected to.

4. The collimating section (1) of claim 2, wherein said is a tube, has no internal collimator and allows the maximum x-ray beam generated from a dental x-ray machine to reach teeth under investigation, and the inside diameter (5) of the collimating section (1) is not less than inside diameter of the output tube of the dental x-ray machine which the dental x-ray radiation protection device of claim 1 is connected to.

5. The dental x-ray radiation protection device of claim 1, wherein said collimating section (1) comprising a clamping mechanism (3), comprises of set screws in order to secure the dental x-ray radiation protection device said in claim 1 to output tube of a dental x-ray machine (7).

6. The clamping mechanism (3) of claim 5 wherein said comprises of set screws may not be limited to set screws and may be of any design to secure the dental x-ray radiation protection device said in claim 1 to the output tube of the dental x-ray machine (7).

7. The collimating section (1) of claim 2, wherein said is a tube, which has wall thickness (9) to provide a portion of radiation reduction.

8. The collimating section (1) of claim 2, wherein said is a tube, the inside wall of the collimating section (1) is covered by radiation protection foil or radiation protection material(s) or composition(s) of various radiation protection materials (2) with a thickness (2) to provide more radiation reduction.

9. The dental x-ray radiation protection device of claim 1, wherein said a clear and transparent x-ray radiation protection section (4), provides the final stage of x-ray radiation reduction and protection against x-ray radiation, has opening (5) comprising of a clear and transparent radiation protection composition(s) or material(s) with a thickness to provide final stage of radiation reduction which is connected to the collimating section (1) of claim 1, and the clear and transparent x-ray radiation protection section (4) and allows dentist or dental assistant to aim the dental x-ray radiation protection device of claim 1 to the targeted teeth.

10. The dental x-ray radiation protection device of claim 1, has opening section (5) for the collimating section (1) of claim 2 and same opening section (5) for clear and transparent x-ray radiation protection section (4) of claim 9 in which the diameter of opening section (5) is not less than diameter of the output tube of the dental x-ray machine (7) and opening section (5) has the same centre point and same central axis which allows all of the x-ray beam and beam cross section (6) to reach patient's teeth under examination.

11. The radiation protection material(s) or radiation protection composition(s) for all parts of radiation protection device of claim 1, and for all parts and their associated components and parts can be any kind of radiation protection material(s) or composition(s) and even sandwich of different radiation protection material(s) and the radiation protection material(s) or radiation protection composition(s) for clear and transparent x-ray radiation protection section (4) is clear and transparent radiation protection material(s) or composition(s).

12. The method for determination of thickness for all parts and their associated components and parts for radiation protection device of claim 1, comprising the steps of:
solving radiation physics equations for thickness of radiation protection material(s) or radiation protection composition(s) (X); and
calculating the thickness of radiation protection material(s) or radiation protection composition(s) (X), with respect to applied x-ray beam intensity, applied beam energy, mass attenuation coefficient and linear attenuation coefficient for the same applied energy and density of applied radiation protection material(s) or radiation protection composition(s) to determine the amount of radiation reduction for each stage and each section in claim 1, to achieve to the maximum percentage of radiation reduction up to 99.9% by using [X=−LnI/I₀×I/μ] and [μ=μₘ.ρ] formulas.

13. The dental x-ray radiation protection device of claim 1, could be moved and adjusted in all directions and angles and in three dimensions with the same movements of a dental x-ray machine when the device is attached to a dental x-ray machine in its mounted frame configuration.

14. The dental x-ray radiation protection device of claim 1, can be constructed compactly or can be an integral part of a dental x-ray machine/equipment/apparatus/generator.

15. The dental x-ray radiation protection device of claim 1, can be designed and manufactured in a way so that its movement is not dependent on the movements of the x-ray machine and is movable and adjustable in all directions and angles and in three dimensions by itself, in its stand frame configuration when supported on a base (FIG. 6).

16. The dental x-ray radiation protection device of claim 15, wherein said its movement is not dependent on the movement of the x-ray machine and is movable and adjustable in all directions and angles by itself such as stand frame which stands on a base, in addition to having a collimating section (1) and a clear and transparent x-ray radiation protection section (4) comprising:
a rod (11) which fits into a vertical tube (13) and rod (11) which has a smaller diameter than vertical tube (13) and can move vertically and rotate and rod (11) which is able to be adjusted vertically by tightening the knob (12);
a horizontal tube (14) in which via a sliding plate (16) both clear radiation protection shield (4) and collimator (1) or assembly (10) is connected to horizontal tube (14);
a sliding plate (16) which allows assembly of collimator (1) and clear radiation protection shield (4) that is connected to the horizontal tube (14) to slide and move along the horizontal tube (14) horizontally and through the space provided by two angles (18);
a set screw (17) locks assembly (10) or assembly collimator (1) and clear radiation protection shield (4) in its horizontal position; and
a frame supported on wheel (15) and supports the assembly of collimator (1), clear radiation protection shield (4), rod (11), vertical tube (13), knob (12), horizontal tube (14), sliding plate (16), set screw (17) and two angles (18).

17. The dental x-ray radiation protection device of claim 1, could be designed and manufactured so that its movement is not dependent on the movement of the x-ray machine and is movable and adjustable in all directions and angles and in three dimensions by itself, and can be hung from ceiling of dental x-ray room or dental examination room and is mounted on adjustable arms, so that the invention does not occupy limited space of the x-ray room (FIG. 8).

18. The dental x-ray radiation protection device of claim 1, could be designed and manufactured so that its movement is not dependent on the movement of the x-ray machine and is movable and adjustable in all directions and angles and in three dimensions by itself, and can be installed from wall of dental x-ray room or dental examination room and is mounted on adjustable arms, so that the invention does not occupy limited space of the x-ray room (FIG. 9).
